(19) United States
(12) Patent Application Publication
(10) Pub. No.: US 2013/0219080 A1
(43) Pub. Date: Aug. 22, 2013

(54) METHOD FOR ROUTING AND ASSOCIATED ROUTING DEVICE AND DESTINATION DEVICE

(71) Applicants: Michel Van Ackere, Sint-Niklaas (BE); Murat Burak Migdisoglu, Antwerp (BE)

(72) Inventors: Michel Van Ackere, Sint-Niklaas (BE); Murat Burak Migdisoglu, Antwerp (BE)

(73) Assignee: ALCATEL LUCENT, Paris (FR)

(21) Appl. No.: 13/806,601

(22) PCT Filed: Jul. 14, 2011
(86) PCT No.: PCT/EP11/62023

§ 371 Date: Feb. 5, 2013

(30) Foreign Application Priority Data
Jul. 19, 2010 (EP) 10305791.5

(51) Int. Cl. H04L 12/56

(52) U.S. Cl. CPC H04L 45/22
USPC 709/238

(57) ABSTRACT

A method for routing in a routing device includes receiving a plurality of data packets of a communication session, and consulting a set of routing rules for each data packet of the plurality of data packets. The set of routing rules indicates on which of at least two egress interfaces of said router each data packet of said plurality of data packets is to be forwarded. The method further includes forwarding each of the plurality of data packets on the respective egress interfaces, deriving information from the plurality of data packets, and deactivating at least one routing rule of the set of routing rules, at least based on whether the information meets predetermined criteria.

### TECHNICAL FIELD OF THE INVENTION

The present invention relates to a method and device for routing of data packets of a communication session between a source device and a destination device.

### BACKGROUND OF THE INVENTION

A wide variety of routing devices, as for instance network routers, the use thereof and methods for routing are known in the state of the art.

It is known that an external control device which is connected to the routing device (e.g. operator, application, etc.) may install a rule on the routing device in a (semi) static way, e.g. by means of Command Line Interface (CLI) commands.

In current solutions, illustrated in FIG. 1, the removal of such a rule from a routing device must be carefully synchronized with the traffic that is matching it (or to which the rule is applicable). When such a rule is removed while matching traffic is running through it, part of the matching traffic can erroneously follow a wrong route. Therefore such a rule typically remains configured for a long period, having a duration much longer than that in which matching traffic is expected, or until the external source is sufficiently sure that it is safe to actively deactivate the rule. This requires the external control device to remain in control of the routing device, even though the external control device may no longer be interested in or able to monitor the traffic that matches that rule after it has configured it. In addition to and as a result of the complex control management, this may lead to many more such rules on such a routing device than are actually required.

An example of a prior art solution can be found in special features of the “iptables” solution in the Linux Operating System (OS) (see for instance http://netfilter.org/projects/patch-o-matic/pom-external.html; iptables “time” match). In this solution the rule remains installed until an external source removes it, even though it is active only for traffic that hits it during a specified time window (e.g. after a specified start time, before a specified stop time, during a repetitive time window, etc.).

### SUMMARY OF THE INVENTION

It is an object of the present invention to provide a method for routing in a routing device according to claim 1, a method for configuring a routing device by a destination device according to claim 11, a routing device according to claim 13, and a destination device adapted for configuring a routing device according to claim 14.

The disclosed methods and devices provide a relatively simple management scheme of routing rules in a routing device.

According to a first aspect of the present invention, a method is disclosed for routing in a routing device of data packets of a communication session between a source device and a destination device. The routing device comprises at least one ingress interface for receiving data packets of the communication session and at least two egress interfaces for forwarding the data packets.

The interfaces can be physical or logical interfaces. In the case for instance of having at least two logical egress interfaces, those interfaces may be supported by a single physical egress interface.

The method preferably comprises performing in the routing device:
a. receiving a plurality of data packets of the communication session;
b. consulting a set of routing rules for each data packet of the plurality of data packets, the set of routing rules indicating on which of the at least two egress interfaces each data packet of the plurality of data packets is to be forwarded;
c. forwarding each of the plurality of data packets on the respective egress interfaces; wherein the method further comprises
d. deriving information from the plurality of data packets;
e. deactivating at least one routing rule of the set of routing rules, at least based on whether the information meets predetermined criteria.

It is an advantage of aspects of the present invention that a routing rule can be locally managed in a routing device and does not need further external control and monitoring after installation of the routing rule.

Deactivating at least one routing rule may comprise or consist of removing the routing rule.

Because the method according to aspects of the present invention allows a local control of the routing rule, i.e. being in the routing device itself, the routing rule can be more efficiently and rapidly removed, which may reduce memory and/or processing capacity of the routing device, as well as of the destination device/ an external device.

The plurality of data packets can be a number of subsequent data packets of a particular data communication session. The plurality of data packets can comprise or consist of the first M (M being a integer value) data packets of a data communication session, as for instance a number of data packets used for session set-up between a source and a destination device. The number of data packets used for session set-up may be known to the destination device, or may be derived by the destination device from the first data packet of the communication session.

According to preferred embodiments, the routing device is a router as for instance an IP router. The routing device may be a basic Internet Protocol routing device or may be a more advanced router which is for instance capable of performing deep packet inspection of packets. The routing device can also be a firewall, or a rule decision device based on layers above layer 4 in the OSI layer. The communication session may be for instance an Internet protocol (IP or TCP or UDP) session. When performing deep packet inspection, information of the packets payload can be analysed, instead of or additionally to the information in the (IP- or TCP- or UDP-)packet header.

The set of routing rules may correspond to or comprise standard routing tables. The set of routing rules may also comprise so-called “policy based routing rules”, which may comprise rules comprised in standard routing tables but also in additional tables used for implementing routing policies in the router.

According to preferred embodiments of the present invention, deriving information from the plurality of data packets comprises analysing characteristics of an arrival sequence of the plurality of data packets, arriving at the routing device. The characteristics of the arrival sequence may for instance comprise the number of data packets of the sequence, the arrival rate, or time related characteristics.

According to preferred embodiments of the present invention, deriving information from the plurality of data packets comprises determining the number of data packets to which a particular routing rule has been applicable, and deactivating at least one routing rule comprises deactivating the particular routing rule. The deactivation can for instance take place when the number of data packets to which a particular routing rule has been applicable equals a predetermined number. It is an advantage of such embodiments that a routing rule can be installed which is active only for a certain number of data packets of a communication session, for instance only to data packets used for session set-up.

According to preferred embodiments of the present invention, the plurality of data packets comprises a first packet having an arrival time and a particular routing rule of the set of routing rules has an installation time, deriving the information comprises determining a time elapsed between the installation time of the particular routing rule and the arrival time of a first packet of the communication session to which the particular routing rule is applicable, and deactivating at least one routing rule comprises deactivating the particular routing rule. The deactivation can for instance take place when the time elapsed reaches a predetermined threshold value. It is an advantage of such embodiments that a routing rule can be removed or deactivated when it does not seem to be applicable to any of the data packets of the plurality of data packets of the data communication session passing in the routing device.

According to preferred embodiments of the present invention, the plurality of data packets comprises a last packet having an arrival time, deriving the information comprises determining a time elapsed since the arrival time of the last packet of the plurality of data packets to which a particular routing rule has been applied, and deactivating at least one routing rule comprises deactivating the particular routing rule. The deactivation can for instance take place when the time elapsed reaches a predetermined threshold value. It is an advantage of such embodiments that a routing rule can be removed or deactivated when it does not seem to be applicable anymore to any of the data packets of the plurality of data packets of the data communication session passing in the routing device.

According to preferred embodiments of the present invention, determining the information comprises deep packet inspection (DPI) of the plurality of data packets. It can be an advantage that information of the packet payload can be analysed, instead of or additionally to the information in the (IP- or TCP- or UDP-)packet header.

According to preferred embodiments of the present invention, deriving information comprises detecting a packet of the communication session which comprises a request for routing rule removal. The detection of an explicit request for removal of a routing rule can for instance be based on the detection of the presence of a specific field in the header of a data packet of the plurality of data packets. It can for instance also be based on a specific format of a data package.

According to preferred embodiments of the present invention, deriving information comprises detecting the presence of a specific field in a data packet of the plurality of data packets.

In embodiments wherein deriving information comprises detecting a packet of the communication session which comprises a request for routing rule removal and/or comprises detecting the presence of a specific field in a data packet of the plurality of data packets, it can be an advantage that the routing device requires less processing and/or memory capacity.

According to preferred embodiments of the present invention, deriving information from the plurality of data packets can comprises analysing the content of the data packets. It may comprise analysing OSI stack level 3 information, as for instance information of the IP-packet header. It may also comprise, for instance for routing devices adapted to perform deep packet inspection, analysing information of the OSI stack level 4 as for instance the TCP or UDP header information.

According to preferred embodiments of the present invention, the method further comprises receiving a routing rule and associated deactivation criteria from the destination device after having forwarded a first data packet of the plurality of data packets to the destination device and before sending a second data packet of the plurality of data packets. It can be an advantage of such embodiments that, upon detection of the type of communication session by the destination device, based on the first packet of the communication session, the destination device can redirect the session before continuing the session set-up, e.g. by forwarding the second packet of the plurality of data packets.

According to a second aspect of the present invention, a method is disclosed for configuring a routing device by a destination device, the routing device routing data packets of a communication session between a source device and the destination device, the routing device comprising at least one ingress interface for receiving data packets of the communication session and at least two egress interfaces for forwarding the data packets, comprising at the destination device
a. receiving a first data packet of the communication session;
b. analysing the first data packet;
c. based on this analysis, determining a routing rule and associated deactivation criteria for the communication session, the routing rule indicating on which of the egress interfaces the data packets are to be forwarded;
d. sending instructions for installing the routing rule and the associated deactivation criteria to the routing device.

The deactivation criteria may, at least in part, be determined by upfront configuration of the destination device, and/or by using information about the communication session between the source and destination device known to the destination device.

According to preferred embodiments, the method further comprises sending a resend request for the first data packet of the communication session to the source device after sending instructions for installing the routing rule and the associated deactivation criteria to the routing device. By sending a resend request for the first data packet of the communication session to the source device, after sending instructions for installing the routing rule and the associated deactivation criteria to the routing device, especially after the installation of the routing rule and the associated deactivation criteria on the routing device, the session setup is reinitiated, and the data communication can (transparently for the source device, i.e. while the source device is unaware) be deflected to an alternative destination device.

According to a third aspect of the present invention, a routing device for use in a data communication network is disclosed, the routing device comprising at least one ingress interface for receiving data packets of a communication session between a source device and a destination device and at least two egress interfaces for forwarding the data packets, a storage means for storing a set of routing rules and associated deactivation criteria for at least one routing rule of the set of routing rules and a means for determining on which of the at least two egress interfaces the received packets are to be forwarded based on the set of at least one routing rule the set of at least one routing rule indicating on which of the at least two egress interfaces the received packets are to be forwarded, wherein the routing device is adapted to deactivate at least one of the set of at least one routing rule at least based on whether information derived from the data packets meets the predetermined criteria.

According to a fourth aspect of the present invention, a destination device adapted for configuring a routing device is disclosed, the routing device routing data packets of a communication session between a source device and the destination device, the routing device comprising at least one ingress interface for receiving data packets of the communication session and at least two egress interfaces for forwarding the data packets, comprising:
a means for analysing a first data packet of the communication session;
a means for determining, based on this analysis, a routing rule and associated deactivation criteria for the communication session, the routing rule indicating on which of the egress interfaces the data packets are to be forwarded;
a means creating an instruction message for installing the routing rule and the associated deactivation criteria on the routing device and for sending the instruction message to the routing device.

According to preferred embodiments, the destination device is further adapted for sending a resend request for the first data packet of the communication session to the source device after sending the instruction message to the routing device.

The features from the dependent claims, features of any of the independent claims and any features of other dependent claims may be combined as considered appropriate to the person of ordinary skill, and not only in the particular combinations as defined by the claims.

Features and advantages of the different aspects of the present invention are equally meant to be disclosed for the other, associated aspects, as would be recognised by the skilled person, and are therefore not repeated for every aspect.

### BRIEF DESCRIPTION OF THE DRAWINGS

The accompanying drawings are used to illustrate embodiments of the present invention.

FIG. 1 illustrates a routing system and associated method according to the prior art.

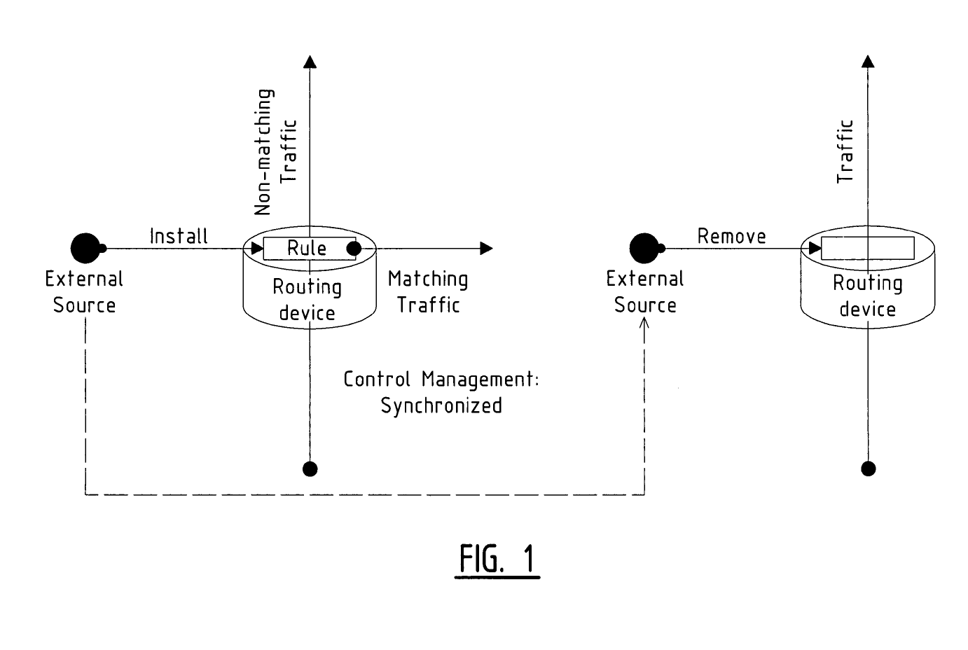

FIG. 2 illustrates a routing system and associated methods according to embodiments of the present invention.

### DESCRIPTION OF ILLUSTRATIVE EMBODIMENTS

The description of aspects of the present invention is performed by means of particular embodiments and with reference to certain drawings but the invention is not limited thereto. Depicted figures are only schematic and should not be considered as limiting.

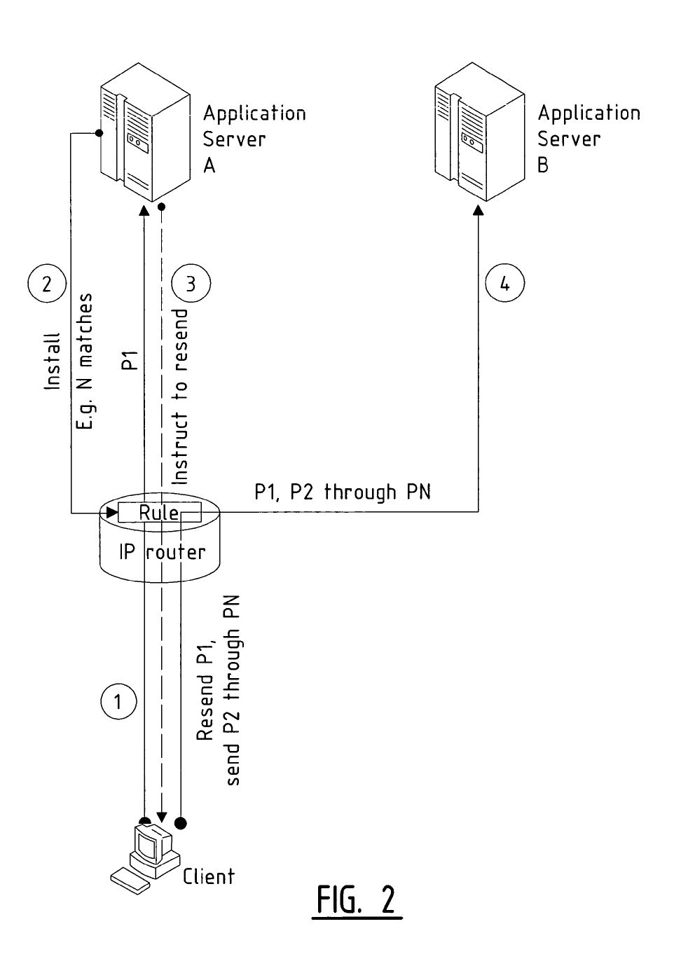

An example embodiment is illustrated in FIG. 2. An IP-router forwards a message/packet sent by a client/source device to an application server/destination device A (P1, step 1).

Upon receiving a 1st message/packet (P1) that A decides not to process (and that allows to derive the amount N of subsequent messages (P1 through PN) to A that A decides not to process), A installs on the IP-router a routing rule/deflection rule, adapted for routing packets towards another application server B for subsequent packets from that client to A (step 2). The source device can be unaware of this process. Then the destination device A instructs the client/source device to resend to A that last received message/packet (P1) before also sending the subsequent N-1 messages (P2 through PN) to A (step 3). The N last messages that the client sends to A actually arrive at (and are responded to by) B (typically without A being aware) (step 4).

After the IP-router has deflected to B the N last messages that the client sent to A, the rule autonomously and automatically “dissolves” in the IP-router, when the router deactivates or removed the rule. From that moment onwards, the IP-router follows other routing rules which are active and typically forwards the subsequent messages which are sent to A by the client/source device again to A.

N can for instance be known from the first message/packet that A decides to defer to B, from upfront configuration of A/destination device or from prior knowledge of the client(source device)/server(destination device) interaction.

The example embodiment is based on the number of matching message packets, being the number of packets to which the rule to be deactivated has been applicable, as a criteria. Other criteria are equally possible, depending on the needs for the client(source device)/server(destination device) interaction.

This example has been described for an IP-router. The proposal is equally applicable for other, non-IP devices in which some routing decision is made based on from externally installed matching/routing rules.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein the instructions perform some or all of the steps of the above-described methods. The program storage devices may be, e.g., digital memories, magnetic storage media such as a magnetic disks and magnetic tapes, hard drives, or optically readable digital data storage media. The embodiments are also intended to cover computers programmed to perform the steps of the above- described methods.

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the FIGS., may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

In the description of certain embodiments according to the present invention, various features are sometimes grouped together in a single embodiment, figure, or description thereof for the purpose of aiding in the understanding of one or more of the various inventive aspects. This is not to be interpreted as if all features of the group are necessarily present to solve a particular problem. Inventive aspects may lie in less than all features of such a group of features present in the description of a particular embodiment.

While some embodiments described herein include some but not other features included in other embodiments, combinations of features of different embodiments are meant to be within the scope of the invention, and form different embodiments, as would be understood by the skilled person.

1. A method for routing in a routing device of data packets of a communication session between a source device and a destination device, said routing device comprising at least one ingress interface for receiving data packets of said communication session and at least two egress interfaces for forwarding said data packets, comprising performing in said routing device:
a. receiving a plurality of data packets of said communication session;
b. consulting a set of routing rules for each data packet of said plurality of data packets, said set of routing rules indicating on which of said at least two egress interfaces each data packet of said plurality of data packets is to be forwarded;
c. forwarding each of said plurality of data packets on the respective egress interfaces; wherein said method further comprises
d. deriving information from said plurality of data packets;
e. deactivating at least one routing rule of said set of routing rules, at least based on whether said information meets predetermined criteria.

2. Method according to claim 1, wherein deriving information from said plurality of data packets comprises analysing characteristics of an arrival sequence of said plurality of data packets, arriving at said routing device.

3. Method according to claim 1, wherein deriving information from said plurality of data packets comprises determining the number of data packets to which a particular routing rule has been applicable, and wherein said deactivating at least one routing rule comprises deactivating said particular routing rule.

4. Method according to claim 1, wherein said plurality of data packets comprises a first packet having an arrival time and wherein a particular routing rule of said set of routing rules has an installation time, wherein deriving said information comprises determining a time elapsed between the installation time of said particular routing rule and the arrival time of a first packet of said plurality of data packets to which said particular routing rule is applicable, and wherein said deactivating at least one routing rule comprises deactivating said particular routing rule.

5. Method according to claim 1, wherein said plurality of data packets comprises a last packet having an arrival time, wherein deriving said information comprises determining a time elapsed since the arrival time of the last packet of said plurality of data packets to which a particular routing rule of said set of routing rules has been applied, and wherein said deactivating at least one routing rule comprises deactivating said particular routing rule.

6. Method according to claim 1, wherein deriving information from said plurality of data packets comprises analysing the content of said plurality of data packets.

7. Method according to claim 6, wherein determining said information comprises deep packet inspection of said plurality of data packets.

8. Method according to claim 6, wherein deriving said information comprises detecting a packet of said communication session which comprises a request for routing rule removal.

9. Method according to any of claim 6, wherein deriving said information comprises detecting the presence of a specific field in a data packet of said plurality of data packets.

10. Method according to claim 1, further comprising receiving a routing rule and associated deactivation criteria from said destination device after having forwarded a first data packet of said plurality of data packets to said destination device and before sending a second data packet of said plurality of data packets.

11. A method for configuring a routing device by a destination device, said routing device routing data packets of a communication session between a source device and said destination device, said routing device comprising at least one ingress interface for receiving data packets of said communication session and at least two egress interfaces for forwarding said data packets, comprising at said destination device
a. receiving a first data packet of said communication session;
b. analysing said first data packet;
c. based on said analysis, determining a routing rule and associated deactivation criteria for said communication session, said routing rule indicating on which of said egress interfaces said data packets are to be forwarded;
d. sending instructions for installing said routing rule and said associated deactivation criteria to said routing device.

12. A method according to claim 11, further comprising sending a resend request for said first data packet of said communication session to said source device after sending instructions for installing said routing rule and said associated deactivation criteria to said routing device.

13. A routing device for use in a data communication network, said routing device comprising at least one ingress interface for receiving data packets of a communication session between a source device and a destination device and at least two egress interfaces for forwarding said data packets, a storage means for storing a set of routing rules and associated deactivation criteria for at least one routing rule of said set of routing rules and a means for determining on which of said at least two egress interfaces said received packets are to be forwarded based on said set of at least one routing rule, said set of at least one routing rule indicating on which of said at least two egress interfaces said received packets are to be forwarded, wherein said routing device is adapted to deactivate at least one of said set of at least one routing rule at least based on whether information derived from said data packets meets said predetermined criteria.

14. A destination device adapted for configuring a router, said router routing data packets of a communication session between a source device and said destination device, said router comprising at least one ingress interface for receiving data packets of said communication session and at least two egress interfaces for forwarding said data packets, comprising:
a means for analysing a first data packet of said communication session;
a means for determining, based on said analysis, a routing rule and associated deactivation criteria for said communication session, said routing rule indicating on which of said egress interfaces said data packets are to be forwarded;
a means for creating an instruction message for installing said routing rule and said associated deactivation criteria on said router and for sending said instruction message to said router.

15. A destination device according to claim 14, further adapted for sending a resend request for said first data packet of said communication session to said source device after sending said instruction message to said router.
